(19) United States
(12) Patent Application Publication
(10) Pub. No.: US 2025/0149582 A1
(43) Pub. Date: May 8, 2025

(54) ELECTRODE, METHOD FOR MANUFACTURING ELECTRODE, AND METHOD FOR MANUFACTURING BATTERY

(71) Applicant: TOYOTA JIDOSHA KABUSHIKI KAISHA, Toyota-shi (JP)

(72) Inventors: Yoshiro OBAYASHI, Toyota-shi (JP); Masahiro ISHIZUKA, Toyota-shi (JP); Takeru HARA, Toyota-shi (JP); Tetsuya MIMURA, Chiryu-shi (JP); Tatsuya KINUGAWA, Kariya-shi (JP); Yusuke YAMAGUCHI, Kariya-shi (JP); Noriyuki MATSUMOTO, Kariya-shi (JP)

(73) Assignee: TOYOTA JIDOSHA KABUSHIKI KAISHA, Toyota-shi (JP)

(21) Appl. No.: 18/883,458

(22) Filed: Sep. 12, 2024

(30) Foreign Application Priority Data
Nov. 8, 2023 (JP) 2023-191162

(51) Int. Cl. H01M 4/60; H01M 4/04; H01M 4/36

(52) U.S. Cl. CPC H01M 4/602; H01M 4/0471; H01M 4/366

(57) ABSTRACT

A method for manufacturing an electrode including a current collector and a resin layer, the method including: welding the current collector and the resin layer to each other using a heater including a heat generator having a lattice-shaped shape.

### CROSS-REFERENCE TO RELATED APPLICATION

This application is based on and claims priority under 35 USC 119 from Japanese Patent Application No. 2023-191162 filed on Nov. 8, 2023, the disclosure of which is incorporated by reference herein.

### BACKGROUND

### Technical Field

The present disclosure relates to an electrode, a method for manufacturing an electrode, and a method for manufacturing a battery.

### Related Art

A battery has been studied, which is provided with an electrode in which a reinforcing member composed of a resin is arranged on an active material-uncoated surface of a current collector, and wrinkling and strain of the current collector are suppressed.

Japanese Patent Application Laid-Open (JP-A) No. 2022-69042 describes “a storage cell including a positive electrode and a negative electrode that each have an active material layer at one surface of a current collector configured by a metal foil and that are arranged so that the active material layers face each other, a separator that is arranged between the positive electrode and the negative electrode and that is interposed between the active material layers, a spacer that is arranged between the positive electrode and the negative electrode and that seals between edge portions of the current collectors so as to surround the active material layers to form an accommodation space in which an electrolytic solution is accommodated, and a reinforcing member that reinforces an uncoated portion of the current collector at which the active material layer is not positioned, wherein the current collector has the uncoated portion between the spacer and the active material layer when viewed from a facing direction in which the active material layers of the positive electrode and the negative electrode face each other, and the reinforcing member is arranged along the uncoated portion so as to extend from a boundary between the active material layer and the uncoated portion to a boundary between the spacer and the uncoated portion when viewed from the facing direction”.

### SUMMARY

An aspect of the present disclosure is a method for manufacturing an electrode including a current collector and a resin layer, the method including: welding the current collector and the resin layer to each other using a heater including a heat generator having a lattice-shaped shape.

### BRIEF DESCRIPTION OF THE DRAWINGS

FIG. 1A is a schematic top view illustrating an example of a structure of an electrode of the present disclosure.

FIG. 1B is a cross-sectional view along line 1B-1B in FIG. 1A.

FIG. 2A is a schematic top view illustrating an example of a welding process according to a method for manufacturing an electrode of the present disclosure.

FIG. 2B is a schematic top view illustrating another example of a welding process according to the method for manufacturing an electrode of the present disclosure.

FIG. 3A is a schematic cross-sectional view illustrating an example of a layer structure and a welding mark in a resin layer after a welding process.

FIG. 3B is a schematic cross-sectional view illustrating another example of a layer structure and a welding mark in a resin layer after a welding process.

FIG. 4 is a schematic side view illustrating an example of a structure of a resin layer after a welding process.

FIG. 5 is a schematic cross-sectional view illustrating an example of a structure of a battery of the present disclosure.

### DETAILED DESCRIPTION

Exemplary embodiments of the present disclosure will be explained below. These explanations exemplify the exemplary embodiments and do not limit the scope of the present disclosure.

In the present specification, a numerical range indicated by using “to” means a range in which numerical values described before and after “to” are included as a minimum value and a maximum value, respectively.

In numerical ranges described in the present exemplary embodiments in a stepwise manner, an upper limit value or a lower limit value described in one numerical range may be replaced with an upper limit value or a lower limit value of another numerical range described in a stepwise manner. Furthermore, in the numerical ranges described in the present exemplary embodiments, an upper limit value or a lower limit value of a numerical range may be replaced with a value indicated in the examples.

In the present specification, the term “process” includes not only independent processes, and even in a case in which a process cannot be clearly distinguished from another process, it is encompassed by this term as long as the intended purpose of the process is achieved.

In the present specification, in cases in which exemplary embodiments are explained with reference to the drawings, configurations of the exemplary embodiments are not limited to the configurations illustrated in the drawings. Furthermore, sizes of members in the respective drawings are conceptual, and relative relationships between the sizes of the members are not limited thereto.

In the present specification, each component may contain plural substances corresponding thereto. In the present exemplary embodiments, in cases in which amounts of respective components in a composition are referred to, when plural substances corresponding to the respective components are present in the composition, unless otherwise specified, this means a total amount of the plural substances present in the composition.

### <Electrode and Method for Manufacturing Electrode>

A method for manufacturing an electrode of the present disclosure is a method for manufacturing an electrode including a current collector and a resin layer, the method including a process of welding the current collector and the resin layer to each other using a heater in which a shape of a heat generating portion (heat generator) is lattice-shaped (hereinafter also referred to as a “welding process”). By including the aforementioned process, an electrode having a current collector in which wrinkling is suppressed is provided.

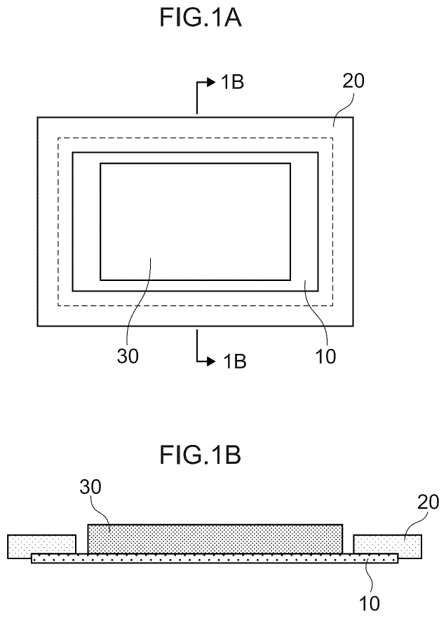

FIG. 1A is a schematic top view illustrating an example of a structure of an electrode of the present disclosure. Furthermore, FIG. 1B is a cross-sectional view along line 1B-1B in FIG. 1A. In FIG. 1A and FIG. 1B, the electrode includes a current collector 10 and a resin layer 20. The resin layer 20 is provided at an active material-uncoated surface of the current collector 10. Furthermore, an active material layer 30 is provided on the current collector 10.

The method for manufacturing an electrode and the electrode of the present disclosure will be described in detail below.

### Current Collector

The current collector preferably includes a positive electrode current collector and a negative electrode current collector, and may be a current collector in which a positive electrode current collector and a negative electrode current collector are bonded to each other.

Examples of the positive electrode current collector include those composed of, for example, nickel, iron, stainless steel (SUS), titanium, or aluminum.

A shape of the positive electrode current collector is, for example, foil-shaped or mesh-shaped.

Among these, from the viewpoint of excellent corrosion resistance and conductivity, the positive electrode current collector is preferably an aluminum foil. The aluminum foil may be subjected to surface processing, and may be subjected to carbon coating.

A thickness of the positive electrode current collector is, for example, from 8 μm to 10 μm.

Examples of the negative electrode current collector include those composed of, for example, copper, stainless steel (SUS), or nickel.

A shape of the negative electrode current collector is, for example, foil-shaped or mesh-shaped.

Among these, from the viewpoint of excellent corrosion resistance and conductivity, the negative electrode current collector is preferably a copper foil.

A thickness of the negative electrode current collector is, for example, from 10 μm to 20 μm.

### Resin Layer

The resin layer is preferably a plate-shaped body containing a resin before the welding process. In a case in which the battery is a laminate-type battery, the resin layer may be a part of a laminate exterior material. The resin layer is provided at a portion or an entirety of an active material-uncoated surface of the current collector after the welding process.

Examples of the resin include polyolefin-based resins. Examples of the polyolefin-based resins include, for example, high-density polyethylene (HDPE), low-density polyethylene (LDPE), linear low-density polyethylene (L-LDPE), and polypropylene (PP). Among these, polypropylene (PP) is particularly preferable from the viewpoint of excellent weldability and electrolytic solution resistance. The polypropylene (PP) may be a modified polypropylene.

A thickness of the resin layer is, for example, from 40 μm to 100 μm.

### (Welding Process)

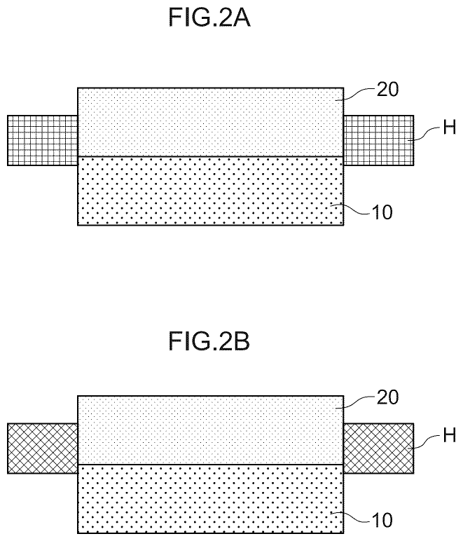

In the method for manufacturing an electrode of the present disclosure, the current collector and the resin layer are welded together using a heater in which a shape of a heat generating portion is lattice-shaped. FIG. 2A and FIG. 2B are schematic top views illustrating an example of the welding process of the method for manufacturing an electrode of the present disclosure.

In FIG. 2A and FIG. 2B, the resin layer 20 is arranged at an uncoated surface of the current collector 10, which is not coated with the active material layer 30, and at a lower portion of the current collector 10, a heater H, which is an example of the heater in which a shape of a heat generating portion is lattice-shaped, is arranged in a thermally connected state. By performing welding using the heater H in which the shape of at least the heat generating portion that contacts the resin layer is lattice-shaped, a battery including a current collector in which wrinkling is suppressed can be obtained.

The term “heater” refers to one including a heat generating body having a heat generating site, and may be either of a contact heater or a non-contact heater, and examples thereof include heaters such as an electric heater, a radiant heater and the like.

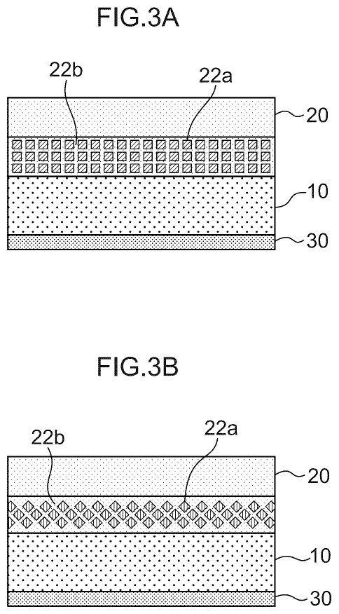

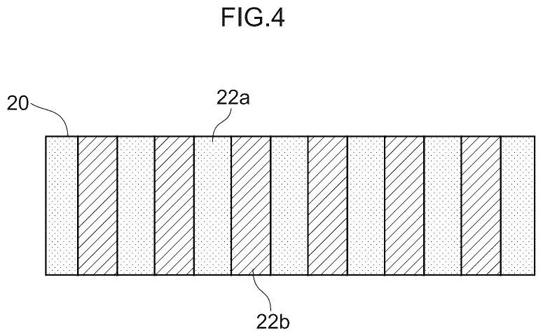

In this regard, transfer of heat from a heater to an object depends on a shape of the heater, particularly in a case in which the heater and the object are in contact. In a case in which the current collector and the resin layer are brought into contact with the heater and welded, in the heating process at the time of welding, a distribution of molten resin in accordance with a shape of the heat generating portion of the heater is formed at the resin layer. At least a portion of the distribution of the molten resin remains even during a cooling and solidification process of a welded portion, and even after the cooling and solidification process. In other words, in a case in which the current collector and the resin layer are welded using a heater in which a shape of a heat generating portion is lattice-shaped, in the heating process at the time of welding, a lattice-shaped distribution of molten resin is formed at the resin layer, and the resin layer is welded to the current collector with at least a portion thereof maintaining this shape. FIG. 3A and FIG. 3B are schematic cross-sectional views illustrating examples of a layer structure and a welding mark in the resin layer after a welding process, and FIG. 4 is a schematic side view illustrating an example of a structure of the resin layer after a welding process. As shown in FIG. 3A, FIG. 3B, and FIG. 4, after the welding process, the resin layer 20 has a lattice-shaped welded portion (welded domain) 22b and unwelded portions (unwelded domains) 22a surrounded by the lattice-shaped welded portion 22b. In the resin layer 20, the unwelded portions 22a and the welded portion 22b are arranged in a lattice shape.

In the method for manufacturing an electrode of the present disclosure, due to having a resin structure in which the resin layer is formed in a lattice shape until the resin layer and the current collector are welded, a portion at which welding is intermittently weak is provided within the welding range, whereby internal stress caused by a difference in a coefficient of thermal expansion between the resin and the current collector generated in the welding process and internal stress caused by a difference in a coefficient of cooling contraction between the resin and the current collector are dispersed in a surface direction of the resin layer. In particular, by forming the lattice-shaped welded portion and forming the plural unwelded portions surrounded by the welded portion, strain accompanying expansion and contraction of the resin at the time of welding is absorbed. As a result, welding to the current collector can be carried out in a state in which wrinkling of the current collector is suppressed. Accordingly, according to the method for manufacturing an electrode of the present disclosure, an electrode having a current collector in which wrinkling is suppressed can be obtained.

Examples of the lattice shape include a planar lattice shape, a lateral lattice shape, a checkerboard lattice shape and the like. From the viewpoint of relaxing internal stress due to expansion or contraction, it is preferable that a number of lattice points per unit area is large. Among the examples, a checkerboard lattice shape is preferable. In a case in which the shape of the heat generating portion of the heater is a checkerboard lattice shape, it is preferable to perform welding in such a manner that the number of lattice points per unit area is increased. For example, the shape of the heat generating portion of the heater H may be a shape shown in FIG. 2A or FIG. 2B. A heating mark of the resin layer after performing heating as shown in FIG. 2A is shown in FIG. 3A. FIG. 3A shows a lattice shape in which rectangular lattices are arranged in such a manner that a direction of lattice arrangement is along a thickness direction of the resin layer and a direction orthogonal thereto. Furthermore, a heating mark of the resin layer after performing heating as shown in FIG. 2B is shown in FIG. 3B. FIG. 3B shows a lattice shape in which rectangular lattices are inclined by 45°, and the inclined rectangular (rhombic) lattices are arranged in such a manner that a direction of lattice arrangement is along the thickness direction of the resin layer and a direction of 45° or −45°.

As the shape of the heat generating portion of the heater H, the shape in FIG. 2A (the welding mark shown in FIG. 3A) is preferable as compared to the shape in FIG. 2B (the welding mark shown in FIG. 3B), due to the fact that stress concentration is less likely to occur when pressure is received from an interior of the electrode, making it easier to favorably maintain sealability.

A welding temperature can be set in a range of equal to or greater than a softening point or a melting point of the resin of the resin layer, is preferably from the softening point or the melting point to 200° C., is more preferably from 130° C. to 200° C., and may be from 130°° C. to 150° C. By performing welding within the aforementioned ranges, the resin can be welded without being excessively plasticized, and also with high welding strength, and therefore, an electrode having a current collector in which wrinkling is suppressed can easily be obtained.

A welding pressure is not particularly limited as long as the current collector and the resin layer can be welded while suppressing wrinkling of the current collector. The welding pressure may be appropriately determined.

A welding method is not particularly limited as long as the current collector and the resin layer can be welded while suppressing wrinkling of the current collector. The current collector and the resin layer may be heated and welded from an upper portion and/or a lower portion with the heater, or may be heated and welded from side portions of the current collector and the resin layer with the heater. Furthermore, from the viewpoint of sealing the electrode, the welding is preferably performed under reduced pressure.

According to the method for manufacturing an electrode of the present disclosure explained above, the present disclosure can provide a method for manufacturing an electrode having a current collector in which wrinkling is suppressed. It is preferable that the electrode of the present disclosure includes the current collector and the resin layer, and that the lattice-shaped welded portion and the unwelded portions surrounded by the lattice-shaped welded portion are included within a welding region of the current collector and the resin layer. The resin layer preferably includes the lattice-shaped welded portion and the unwelded portions surrounded by the lattice-shaped welded portion. According to the present disclosure, among lattice shapes, it is preferable that the lattice shape is a checkerboard lattice shape.

Furthermore, the method for manufacturing an electrode of the present disclosure may include, in addition to the aforementioned welding process, other processes for manufacturing a battery (for example, a series of processes including a kneading process, a coating process, a drying process, a pressing process, a slitting process or the like (i.e., an active material layer forming process, which will be described later)). The method for manufacturing an electrode of the present disclosure preferably includes processes for respectively forming a positive electrode active material layer or a negative electrode active material layer on a current collector (hereinafter also referred to as an “active material layer forming process”).

In the kneading process, a positive electrode active material or a negative electrode active material, a conductive material, and a binder are kneaded to prepare a slurry for a positive electrode or a negative electrode. The kneading may be performed by a known method, and may be performed using, for example, a planetary mixer, a sand mill, a ball mill, a planetary mill, a roll mill, an extruder or the like.

In the coating process, the slurry for forming the positive electrode active material layer or the negative electrode active material layer is respectively applied to the positive electrode current collector or the negative electrode current collector. The coating may be performed by a known method, and may be performed, for example, by a slit die method or a doctor roll method.

In the drying process, the slurry that has been coated to form the positive electrode active material layer or the negative electrode active material layer is dried. The drying is performed, for example, at from 80° C. to 135° C.

In the pressing process, the dried positive electrode or negative electrode is pressed and rolled. The pressing is performed, for example, by roll pressing, cold isostatic pressing (CIP) or the like. A pressure of the pressing is, for example, from 1.0 t/cm² to 3.0 t/cm².

In the slitting process, the rolled positive electrode or negative electrode is cut into predetermined sizes. The slitting can be carried out according to a known method.

### <Method for Manufacturing Battery>

A method for manufacturing a battery of the present disclosure includes at least a process of manufacturing an electrode by the method for manufacturing an electrode of the present disclosure described above (hereinafter also referred to as an “electrode manufacturing process”), a process of manufacturing a laminated body by laminating the electrode via a separator (hereinafter also referred to as a “laminated body manufacturing process”), and a process of sealing the laminated body by welding the resin layer included in the electrode (hereinafter also referred to as a “sealing process”), and may include a connection process, a lamination process or the like, as necessary.

In the lamination process, electrodes are alternately laminated via a separately prepared solid electrolyte layer or separator to manufacture a laminated body. The laminating can be performed, for example, using a known lamination apparatus.

In the sealing process, the laminated body is sealed by welding the resin layer included in the electrode. The welding can be performed using an ultrasonic welding apparatus or the like.

Furthermore, in a case in which the connection process is included, a side surface member (a terminal or the like) is connected to the current collector (the positive electrode current collector and/or the negative electrode current collector). The terminal connection can be performed, for example, by using an ultrasonic welding apparatus.

In a case in which the lamination process is included, a laminate body can be configured by covering an electrode body including the electrode and the active material layer of the present disclosure with a laminate exterior material and carrying out thermal fusion.

In a case in which the battery including the electrode of the present disclosure is, for example, a laminate-type battery, the battery can be manufactured through a process of lamination using the laminate exterior material.

### <Battery>

In addition to including the electrode having the current collector and the resin layer, the battery of the present disclosure preferably incudes a positive electrode active material layer, a negative electrode active material layer, and a solid electrolyte layer or a separator. Furthermore, in a case in which the battery is not an all-solid-state battery, it is preferable that the battery is provided with a separator and incudes a liquid electrolyte.

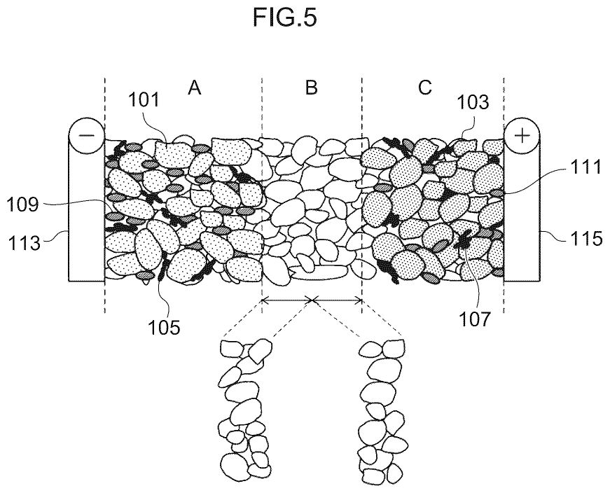

FIG. 5 is a schematic cross-sectional view illustrating an example of a structure of a battery of the present disclosure. In FIG. 5, the battery incudes a negative electrode current collector 113, a negative electrode active material layer A, a solid electrolyte layer B or a separator B, a positive electrode active material layer C, and a positive electrode current collector 115. The negative electrode active material layer A includes a negative electrode active material 101, a conductive material 105, and a binder 109. The positive electrode active material layer C contains a positive electrode active material 103, a conductive material 107, and a binder 111. The solid electrolyte layer B or the separator B may have a single-layer structure, or may have a multilayer structure.

### Positive Electrode Active Material Layer

The positive electrode active material layer preferably includes a positive electrode active material.

Examples of the positive electrode active material include a lithium composite oxide.

The lithium composite oxide may include at least one selected from the group consisting of F, CI, N, S, Br and I.

A shape of the positive electrode active material is not particularly limited. For example, it may be spherical (for example, truly spherical, elliptically spherical or the like), fibrous or the like.

In a case in which the positive electrode active material is spherical, a particle size is, for example, from 0.1 μm to 30 μm.

A specific surface area of the positive electrode active material is, for example, from 0.1 m²/g to 100 m²/g.

### Negative Electrode Active Material Layer

The negative electrode active material layer preferably contains a negative electrode active material.

Examples of the negative electrode active material include, for example, Li-based active materials such as metallic lithium or the like, carbon-based active materials such as graphite or the like, oxide-based active materials such as lithium titanate (for example, Li₄T₁₅O₁₂) or the like, and Si-based active materials such as Si simple substance or the like.

A shape of the negative electrode active material is not particularly limited. For example, it may be spherical (for example, truly spherical, elliptically spherical or the like), fibrous or the like.

In a case in which the negative electrode active material is spherical, a particle size is, for example, from 0.1 μm to 30 μm.

A specific surface area of the negative electrode active material is, for example, from 0.1 m²/g to 1500 m²/g.

The positive electrode active material layer and the negative electrode active material layer preferably also include a conductive material and a binder. By including the conductive material, conductivity between the active material, and between the active material and the current collector, can be improved. Furthermore, by including the binder, it is possible to cause binding between the active material, and between the active material and the current collector.

Examples of the conductive material include, for example, acetylene black, Ketjen black, vapor grown carbon fiber (VGCF (registered trademark)), carbon nanotubes and the like.

A content of the conductive material is, for example, from 3% by mass to 5% by mass with respect to the active material.

Examples of the binder include binders such as polyvinylidene fluoride (PVDF)/NMP-based binders, styrene butadiene rubber (SBR)/water-based binders, and the like.

A content of the binder is, for example, from 3% by mass to 5% by mass with respect to the active material.

### Solid Electrolyte Layer

In a case in which the battery of the present disclosure is a solid-state battery (for example, an all-solid-state battery), the battery preferably includes a solid electrolyte layer.

Examples of the solid electrolyte include, for example, at least one solid electrolyte selected from the solid electrolyte group consisting of sulfide solid electrolytes, oxide solid electrolytes, and halide solid electrolytes.

A shape of the solid electrolyte is not particularly limited. For example, it may be spherical (for example, truly spherical, elliptically spherical or the like), fibrous or the like. In a case in which the solid electrolyte is spherical, a particle size is, for example, from 0.01 μm to 1 μm.

A specific surface area of the solid electrolyte is, for example, from 25 m²/g to 30 m²/g.

### Separator

In a case in which the battery of the present disclosure includes a liquid electrolyte (electrolytic solution), the battery preferably includes a separator. Examples of the separator include, for example, resin sheets of polyethylene (PE) or polypropylene (PP), or the like.

### Liquid Electrolyte

Examples of the liquid electrolyte include, for example, carbonate-based solvents such as ethylene carbonate (EC), propylene carbonate (PC), dimethyl carbonate (DMC) or the like, which contain a salt such as LiPF₆, LiBF₄, LiAsF₆ or the like at a concentration of from 0.1 mol/L to 1 mol/L.

Upon assembling the battery, since the resin thermally expands or contracts when the current collector and the resin layer are welded, there is a risk that wrinkling may occur in the current collector accompanying this expansion or contraction. Thus, there is still room for improvement in this regard. Wrinkling of the current collector leads to scratching or tearing of the current collector, and also reduces sealability of the electrolytic solution of the battery.

A problem to be solved by an exemplary embodiment of the present disclosure is to provide an electrode having a current collector in which wrinkling is suppressed, and a method for manufacturing the electrode.

A problem to be solved by another exemplary embodiment of the present disclosure is to provide a method for manufacturing a battery including an electrode having a current collector in which wrinkling is suppressed.

The present disclosure includes the following aspects.

A first aspect of the present disclosure is a method for manufacturing an electrode including a current collector and a resin layer, the method including: welding the current collector and the resin layer to each other using a heater including a heat generating portion having a lattice-shaped shape.

A second aspect of the present disclosure is the method for manufacturing an electrode according to the first aspect, further including respectively forming a positive electrode active material layer or a negative electrode active material layer on the current collector.

A third aspect of the present disclosure is an electrode including a current collector and a resin layer, and including a lattice-shaped welded portion and an unwelded portion surrounded by the lattice-shaped welded portion, within a welding region of the current collector and the resin layer.

A fourth aspect of the present disclosure is a battery including the electrode according to the third aspect.

A fifth aspect of the present disclosure is a method for manufacturing a battery, the method including: manufacturing an electrode including a current collector and a resin layer by welding the current collector and the resin layer to each other using a heater including a heat generating portion having a lattice-shaped shape; manufacturing a laminated body by laminating the electrode via a separator; and sealing the laminated body by welding the resin layer included in the electrode.

According to an exemplary embodiment of the present disclosure, an electrode having a current collector in which wrinkling is suppressed, and a method for manufacturing the electrode, are provided.

According to another exemplary embodiment of the present disclosure, a method for manufacturing a battery including an electrode having a current collector in which wrinkling is suppressed is provided.

What is claimed is:

1. A method for manufacturing an electrode including a current collector and a resin layer, the method comprising:
welding the current collector and the resin layer to each other using a heater including a heat generator having a lattice-shaped shape.

2. The method for manufacturing an electrode according to claim 1, further comprising respectively forming a positive electrode active material layer or a negative electrode active material layer on the current collector.

3. An electrode comprising a current collector and a resin layer, and including a lattice-shaped welded domain and an unwelded domain surrounded by the lattice-shaped welded domain, within a welding region of the current collector and the resin layer.

4. A battery comprising the electrode according to claim 3.

5. A method for manufacturing a battery, the method comprising:
manufacturing an electrode including a current collector and a resin layer by welding the current collector and the resin layer to each other using a heater including a heat generator having a lattice-shaped shape;
manufacturing a laminated body by laminating the electrode via a separator; and
sealing the laminated body by welding the resin layer included in the electrode.
